(19) United States
(12) Patent Application Publication
(10) Pub. No.: US 2026/0220813 A1
(43) Pub. Date: Jul. 30, 2026

(54) INFORMATION PROCESSING APPARATUS, METHOD OF CONTROLLING INFORMATION PROCESSING APPARATUS, SYSTEM, AND NON-TRANSITORY COMPUTER READABLE STORAGE MEDIUM

(71) Applicant: CANON KABUSHIKI KAISHA, Tokyo (JP)

(72) Inventor: RYOJI MATSUHASHI, Kanagawa (JP)

(21) Appl. No.: 19/578,416

(22) Filed: Mar. 25, 2026

Related U.S. Application Data
(63) Continuation of application No. PCT/JP2024/033605, filed on Sep. 20, 2024.

(30) Foreign Application Priority Data
Oct. 3, 2023 (JP) 2023-171953

(51) Int. Cl. G06T 7/73; G06T 7/246; G06T 17/00

(52) U.S. Cl. CPC G06T 7/73; G06T 7/246; G06T 17/00

(57) ABSTRACT

An information processing apparatus communicating with a display apparatus, the information processing apparatus comprising: one or more processors and/or circuitry configured to execute acquisition processing of acquiring a detection result of an inertial sensor included in the display apparatus, and a captured image from an imaging unit included in the display apparatus; execute detection processing of detecting a feature point of a subject from the captured image; execute determination processing of determining whether the feature point corresponds to a first feature point group or a second feature point group different from the first feature point group, based on the detection result and the feature point; and execute estimation processing of performing estimation of a position or an orientation of the display apparatus based on the first feature point group, or estimation of a position or an orientation of the display apparatus based on the second feature point group.

### CROSS-REFERENCE TO RELATED APPLICATIONS

This application is a Continuation of International Patent Application No. PCT/JP2024/033605, filed September 20, 2024, which claims the benefit of Japanese Patent Application No. 2023-171953, filed October 3, 2023, both of which are hereby incorporated by reference herein in their entirety.

### BACKGROUND

### Field of the Technology

The present disclosure relates to an information processing apparatus, a method of controlling an information processing apparatus, an information processing system, and a non-transitory computer readable storage medium.

### DESCRIPTION OF THE RELATED ART

In recent years, a mixed reality (MR) technique and a virtual reality (VR) technique that make a user feel a space different from a real space by using a head-mounted display (HMD) are known. In such techniques, it has been considered that the user performs various kinds of control on the HMD while wearing the HMD. The HMD performs control by acquiring a position and an orientation of the HMD from information by an acceleration sensor and an angular velocity sensor that are incorporated in the HMD.

In a case where a user uses an HMD as described above while riding in a vehicle such as an automobile, information obtained from an acceleration sensor and an angular velocity sensor includes information on motion of the user as well as information on motion of the vehicle. This may cause an issue that a video image not corresponding to a moving amount and a moving direction of the user inside the vehicle is displayed on a video display apparatus. To solve the issue, Japanese Patent Laid-Open No. 2019-049831 describes a technique for determining a video image to be displayed on the HMD by subtracting information on motion of the vehicle acquired from a motion sensor disposed on the vehicle from information on motion of the user acquired from a motion sensor disposed on a body of the user.

### SUMMARY

The existing technique disclosed in the above-described patent literature requires labor and time for separately preparing the motion sensor to be disposed on a vehicle that is unnecessary in a case where the user uses the HMD while not riding in the vehicle. Thus, the present disclosure is directed to an information processing apparatus that can distinguish and acquire a position and an orientation of the user including a position and an orientation of a moving body, and a position and an orientation of the user inside the moving body, without requiring a separate motion sensor in a case where the user rides in the moving body.

According to an aspect of the present disclosure, an information processing apparatus communicating with a display apparatus includes one or more processors and/or circuitry configured to execute first acquisition processing of acquiring a detection result of an inertial sensor included in the display apparatus, execute second acquisition processing of acquiring a captured image from an imaging unit included in the display apparatus, execute detection processing of detecting a feature point of a subject from the captured image acquired in the second acquisition processing, execute determination processing of determining whether the feature point corresponds to a first feature point group or a second feature point group different from the first feature point group, based on the detection result of the inertial sensor acquired in the first acquisition processing, and the feature point detected in the detection processing, and execute estimation processing of performing estimation of a position or an orientation of the display apparatus based on the first feature point group, or estimation of a position or an orientation of the display apparatus based on the second feature point group.

Features of the present disclosure will become apparent from the following description of embodiments with reference to the attached drawings.

### BRIEF DESCRIPTION OF THE DRAWINGS

FIG. 1 is a diagram illustrating an information processing system according to a first embodiment.

FIG. 2 is a block diagram according to the first embodiment.

FIG. 3 is a diagram illustrating a scene where a user uses a head-mounted display (HMD) 100 while riding in a mobile body.

FIG. 4 is a diagram illustrating self-position estimation processing using a camera video image.

FIG. 5 is a diagram illustrating moving amount calculation processing using a position and an orientation acquired by an orientation sensor unit 204.

FIG. 6 is a diagram illustrating self-position estimation processing and moving amount calculation processing based on a position and an orientation detected by the orientation sensor unit 204 in a case where the moving body moves and the user also moves inside the moving body.

FIG. 7 is a flowchart illustrating a procedure of processing by an information processing apparatus.

### DESCRIPTION OF THE EMBODIMENTS

Embodiments will be described in detail below with reference to accompanying drawings. Note that the following embodiments do not limit the disclosure according to the claims. Although a plurality of features is described in the embodiments, all of the plurality of features are not necessarily essential for the disclosure, and the plurality of features may be optionally combined. Further, in the accompanying drawings, the same or similar components are denoted by the same reference numerals, and repetitive description is omitted.

### First Embodiment

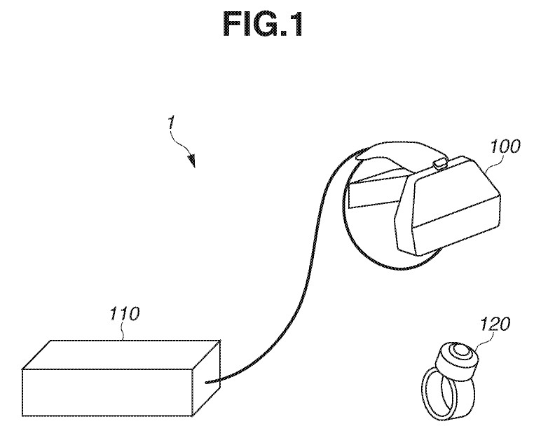

An information processing system 1 according to a first embodiment will be described with reference to FIG. 1. The information processing system 1 includes a head-mounted display (HMD) 100, a personal computer (PC) 110, and a controller 120.

The HMD 100 is a head-mounted display apparatus (electronic apparatus) that can be mounted on the user's head. The HMD 100 displays a combined image obtained by combining a captured image that is an image of a range in front of the user captured by the HMD 100, and contents such as computer graphics (CG) in a form corresponding to an orientation of the HMD 100.

The PC 110 controls the HMD 100. The PC 110 is connected to the HMD 100 by a wired cable such as a universal serial bus (USB) cable, or by radio such as Bluetooth^{®} and Wireless Fidelity (Wi-Fi^{®}). The PC 110 combines the captured image and the CG to generate a combined image, and transmits the combined image to the HMD 100. Note that a PC will be described as an example of the information processing apparatus; however, the information processing apparatus is not limited thereto. For example, the information processing apparatus may be a smartphone or a tablet terminal, and components of the PC 110 may be included in the HMD 100.

The controller 120 performs various kinds of control of the HMD 100. When the PC 110 operates in a specific control mode, and the user operates the controller 120, the HMD 100 is controlled based on the operation by the user. As illustrated in FIG. 1, the controller 120 may be a ring type that can be worn and supported on a user's finger, or a hand-held type held by a user's hand. The controller 120 includes a physical button for performing determination operation or selection operation on a display screen. The controller 120 performs Bluetooth^{®} wireless communication with the PC 110. The controller is not limited to a system configured to communicate with the PC 110, and may alternatively be a system configured to communicate with the HMD 100.

The user can change an instruction position on the display corresponding to movement of the controller by moving the controller 120. The instruction position is sometimes represented by a point, or by a virtual ray connecting the point of the instruction position and the controller with a straight line (line segment) or a dotted line. When the physical button is pressed, determination operation or selection operation of a menu can be performed. As the shape of the controller 120, the ring shape and the hand-held shape are described above; however, the shape of the controller 120 is not limited thereto as long as the controller 120 can be supported by a finger, a hand, or an arm. Further, the button is described as the physical button; however, any other member such as a trackpad, a touch panel, a wheel, and a trackball may also be used as long as operation can be performed with the member, and the operation may alternatively be slide operation, flick operation, or touch operation in addition to pressing of the button.

The controller may also be worn on a finger, hand, and/or arm.

The controller may also be attached to an object held by a hand, and positional information and orientation information on an attachment position may be acquired from a sensor. Examples of such an object include an object shaped like a tool.

### Internal Configuration of HMD

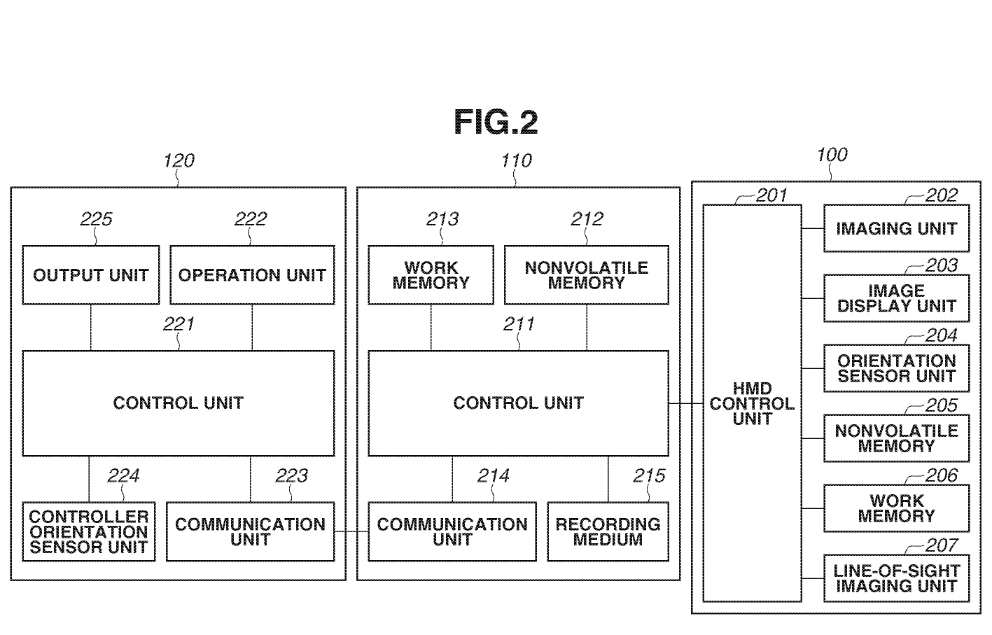

An internal configuration of the HMD 100 will be described with reference to FIG. 2. The HMD 100 includes an HMD control unit 201, an imaging unit 202, an image display unit 203, an orientation sensor unit 204, a nonvolatile memory 205, a work memory 206, and a line-of-sight imaging unit 207.

The HMD control unit 201 is a central processing unit (CPU) for controlling the components of the HMD 100. The HMD control unit 201 acquires the combined image (image obtained by combining captured image that is an image of space in front of the user captured by the imaging unit 202, and CG) from the PC 110, and then displays the combined image on the image display unit 203. In place of controlling the entire apparatus by the HMD control unit 201, a plurality of pieces of hardware may share processing to control the entire apparatus.

The imaging unit 202 includes two cameras (imaging apparatuses). The two cameras capture a captured image used to be combined with an image of a virtual space and to generate position and orientation information, and include a left-eye imaging unit and a right-eye imaging unit. The left-eye imaging unit captures a moving image of a real space corresponding to a left eye of a wearer of the HMD 100, and outputs images (captured images) of respective frames in the moving image. The right-eye imaging unit captures a moving image of the real space corresponding to a right eye of the wearer of the HMD 100, and outputs images (captured images) of respective frames in the moving image. In other words, the imaging unit 202 acquires the captured image as a stereo image having a parallax substantially coincided with positions of the left eye and the right eye of the wearer of the HMD 100. Further, by ranging performed by the stereo camera, information on a distance from the two cameras to an object can be acquired as distance information. In the HMD for a mixed reality (MR) system, a center optical axis of an imaging range of the imaging unit may be disposed so as to be substantially coincident with a line-of-sight direction of the wearer of the HMD.

Each of the left-eye imaging unit and the right-eye imaging unit includes an optical system and an imaging device. Light having entered from the outside world enters the imaging device through the optical system, and the imaging device outputs an image corresponding to the incident light, as a captured image. Images of the object (range in front of user) captured by the two cameras are output to the PC 110 and the HMD control unit 201. The imaging unit 202 may capture and output video images in place of captured images.

The image display unit 203 displays the combined image. The image display unit 203 includes a liquid crystal panel, an organic electroluminescence (EL) panel, and the like. In a state where the user wears the HMD 100, the image display unit 203 is disposed in front of the eyes of the user. A device using a semi-transmissive half mirror may be used as the image display unit 203. In this case, for example, the image display unit 203 may display an image such that a CG appears as if the CG is directly superimposed on a real space visible through the half mirror, by using a technique generally referred to as augmented reality (AR). The image display unit 203 may display an image of a complete virtual space without using the captured image by using a technique generally referred to as virtual reality (VR).

The orientation sensor unit 204 is a motion sensor acquiring information on orientation (and position) of the HMD 100. The orientation sensor unit 204 may acquire information on orientation of the user (user wearing HMD 100) corresponding to the orientation (and position) of the HMD 100. The orientation sensor unit 204 includes an inertial measurement unit (IMU) consisting of an inertial sensor, such as an acceleration sensor and an angular acceleration sensor, and a geomagnetic sensor. The orientation sensor unit 204 is used to acquire information on the user's orientation (orientation information), and the HMD control unit 201 outputs a detection result of the information on the user's orientation (orientation information) to the PC 110. The orientation information may be acquired from one or more of a magnetic sensor (including geomagnetic sensor), an ultrasonic sensor, an acceleration sensor, and an angular velocity sensor.

The HMD control unit 201 estimates positions or orientations of joint points of the user's hands and fingers from images of the two cameras obtained by the imaging unit 202. The joint points include feature points of parts such as joints of fingers, fingertips, back of hands (palm of hands), and arms. Each of the joint points indicates a coordinate position, and the orientation can be estimated from information on the plurality of joint points. As a method of estimating the positions or orientations of the hands and the joint points of the hands, for example, a known object recognition or pose estimation method by machine learning using a convolutional neural network can be used. Further, positional information on each of the joint points of the hands in a depth direction can be obtained by calculating a distance from the imaging unit 202 to each of the joint points through, for example, triangulation by stereo matching using the two camera images obtained by the imaging unit 202. The estimated coordinate information on each of the joint points of the hands is output from the HMD control unit 201 to the PC 110.

The nonvolatile memory 205 is an electrically erasable and writable nonvolatile memory, and stores programs to be executed by a control unit 211 described below, and the like.

The work memory 206 is used as a buffer memory that temporarily stores image data captured by the imaging unit 202, an image display memory for the image display unit 203, a work area for the HMD control unit 201, and the like.

The line-of-sight imaging unit 207 is a camera that acquires an image for detecting a line of sight of the user, and the line-of-sight imaging unit 207 is attached to an inside of the HMD to capture an image of the user's eyes when the user wears the HMD 100. An image of an object (user's eyes) captured by the camera is output to the control unit 211 of the PC 110 through the HMD control unit 201. The control unit 211 detects the line of sight of the user who is wearing the HMD 100 from the image captured by the line-of-sight imaging unit 207, and specifies a portion of the image display unit 203 gazed by the user.

### Internal Configuration of Controller

An internal configuration of the controller 120 is now described with reference to FIG. 2. The controller 120 includes a control unit 221, an operation unit 222, a communication unit 223, and a controller orientation sensor unit 224.

The control unit 221 is a CPU configured to control the components of the controller 120. In place of controlling the entire apparatus by the control unit 221, a plurality of pieces of hardware may share processing to control the entire apparatus.

The operation unit 222 includes a button. The operation unit 222 detects whether the button has been operated, and transmits detection information to the PC 110 through the communication unit 223. The operation unit 222 may also include a plurality of types of input formats.

The communication unit 223 performs Bluetooth^{®} wireless communication with the PC 110. In a case where a plurality of controllers is provided, each of the controllers performs Bluetooth^{®} wireless communication with the PC 110.

The controller orientation sensor unit 224 includes an inertial measurement unit (IMU) consisting of an inertial sensor, such as an acceleration sensor and an angular acceleration sensor, and a geomagnetic sensor. The IMU detects a change of a position or an orientation of the controller 120. The detected change information on the position and the orientation is communicated from the communication unit 223 to the PC 110 through the control unit 221.

An output unit 225 includes a light source of a light-emitting diode (LED), a speaker, a vibration element, and the like.

### Internal Configuration of PC

An internal configuration of the PC 110 will now be described with reference to FIG. 2. The PC 110 includes the control unit 211, a nonvolatile memory 212, a work memory 213, a communication unit 214, and a recording medium 215.

The control unit 211 is a CPU configured to control each unit of the PC 110 in accordance with input signals and programs described below. In place of controlling the entire apparatus by the control unit 211, a plurality of pieces of hardware may share processing to control the entire apparatus. The control unit 211 receives the image (captured image) acquired by the imaging unit 202 and the orientation information acquired by the orientation sensor unit 204 from the HMD 100. The control unit 211 performs image processing for cancelling aberration in the optical systems of the imaging unit 202 and an optical system of the image display unit 203, on the captured image. Further, the control unit 211 combines the captured image and an optional CG to generate a combined image. The control unit 211 transmits the combined image to the HMD control unit 201 of the HMD 100.

Further, the control unit 211 determines the number of controllers included in the captured image. Furthermore, the control unit 211 performs processing for recognizing an attachment position of each of the controllers by using information acquired through the communication unit 214. The control unit 211 then performs control to change operation contents with respect to the input information on each of the controllers, based on the recognized result.

The control unit 211 controls a position, a direction, and a size of the CG in the combined image based on the information (distance information and orientation information) acquired by the HMD 100. For example, in a case where, in a space represented by the combined image, a virtual object indicated by the CG is disposed near a specific object present in the real space, the control unit 211 increases the size of the virtual object (CG) as a distance between the specific object and the imaging unit 202 is smaller. Further, for example, the control unit 211 draws the virtual object (CG) in accordance with changes of the position and the orientation of the HMD 100 thereby drawing the CG changed in position and direction together with the HMD 100 and a CG not based on changes of the position and the orientation of the HMD 100, and combining the CG with the real image. As described above, by controlling the position, the direction, and the size of the CG, the control unit 211 can generate a combined image as if a CG object not disposed in the real space is disposed in the real space.

Further, the control unit 211 receives information estimated by the HMD control unit 201 of the HMD 100. The received information is temporarily stored in the work memory 213.

The control unit 211 also receives change information on the position or the orientation of the controller 120 from the communication unit 223 of the controller 120 through the communication unit 214. The control unit 211 superimposes and displays an instruction position corresponding to the change information on the position or the orientation of the controller 120 on the combined image. The control unit 211 may superimpose and display an instruction position corresponding to the change information on the position and the orientation of the controller 120 on the combined image.

The nonvolatile memory 212 is an electrically erasable and writable nonvolatile memory, and stores information such as programs to be executed by the control unit 211 described below, and a CG. The control unit 211 can switch a CG (i.e., CG used to generate combined image) to be read out from the nonvolatile memory 212.

The work memory 213 is used as a buffer memory that temporarily stores image data captured by the imaging unit 202 and time-series information on the estimated coordinate position of each of the joint points of the hands, an image display memory for the image display unit 203, a work area for the control unit 211, and the like.

Estimation of the joint points of the hands may be performed by the PC 110. In this case, after the imaging unit 202 outputs the captured image to the PC 110, the control unit 211 of the PC 110 estimates the position or the orientation of each of the joint points of the hands, processes the image by using the information, and outputs a resultant image to the HMD 100. The control unit 211 may estimate the position and the orientation of each of the joint points of the hands, process the image by using the information, and output a resultant image to the HMD 100.

Other than the components of the MR system, for example, the control unit of any of the HMD 100 and the PC 110 performs various kinds of image processing on the captured image acquired by the imaging unit 202 and the displayed image displayed on the image display unit 203. However, the processing is not a primary object of the present disclosure, and accordingly, description thereof will be omitted.

### Use Example of Information Processing Apparatus

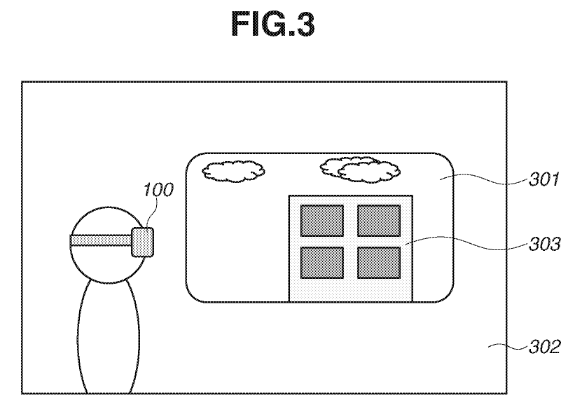

A scene where the user uses the HMD 100 while riding in a moving body such as a vehicle and a train will now be described with reference to FIG. 3. FIG. 3 illustrates an example in which the user wears the HMD 100 on a head. An outside landscape appears in a window 301 provided on the vehicle or the train, and during movement of the moving body, the landscape changes according to a moving speed of the moving body. In FIG. 3, a building 303 appears as the outside landscape. The change of the landscape is captured as a camera video image by the imaging unit 202. For example, the moving body may be a convertible with no window, and the landscape may be directly displayed not through the window. Further, the camera video image captured by the imaging unit 202 includes an internal scene 302 including a wall and a door inside the moving body.

### Self-Position Estimation Using Camera Video Image

As a self-position estimation method using the camera video image, a simultaneous localization and mapping (SLAM) is known. The SLAM is disclosed as a method of detecting positions of feature points in the camera video image, and determining a self-position in a three-dimensional space from a moving amount of the position of each feature point between frames. It has been known to estimate a self-position in the three-dimensional space from these feature points using various disclosed algorithms of the SLAM.

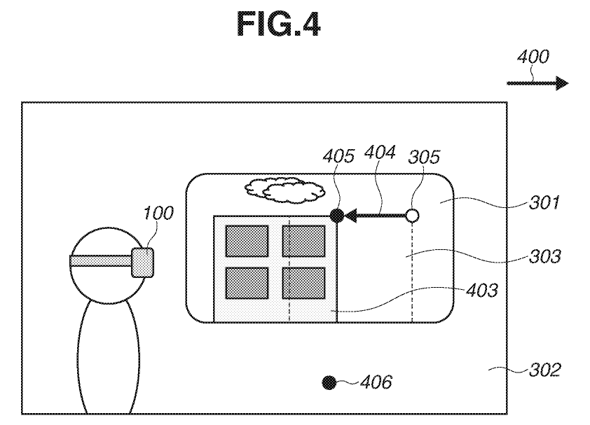

The self-position estimation processing using a camera video image will now be described with reference to FIG. 4. FIG. 4 illustrates an example of the self-position estimation using the camera video image, and is a diagram as viewed from a third party. FIG. 4 illustrates movement by a length of an arrow in a direction indicated by the moving amount 400 from the state illustrated in FIG. 3. The building 303 is observed from the inside of the moving body as if the building 303 has been moved by a length of an arrow of a moving amount 404 in a direction opposite to the direction indicated by the moving amount 400. FIG. 4 illustrates a case where the user does not move inside the moving body.

In a case where the user is in the moving body, the camera video image displays the window 301 provided on the moving body and the internal scene 302 including a wall and a door inside the moving body.

In a case where the moving body moves, and the user also moves inside the moving body, a moving amount linked with movement of the moving body as well as movement of the user itself is detected from an outside feature point detected in the window 301 provided on the moving body. In this example, since the user does not move, the building 303 illustrated by a dotted line is relatively moved, and is observed at a position of a building 403 from the HMD. For example, it is detected that a feature point 405 of the building 403 obtained at a time point illustrated in FIG. 4 has been moved by the moving amount 404 from a feature point 305 detected at a time point illustrated in FIG. 3 between the frame illustrated in FIG. 3 and the frame illustrated in FIG. 4. In a case where the self-position estimation is performed using the outside feature point detected in the window 301 provided on the moving body, the self-position of the HMD 100 outside the moving body can be estimated.

As for a feature point of the internal scene 302 including a wall and a door inside the moving body, a moving amount unrelated to movement of the moving body is detected. In a case where the user moves inside the moving body, a moving amount of the user inside the moving body is detected. For example, since the user does not move, a feature point 406 of the internal scene 302 is detected as an unmoved feature point from the HMD. In a case where the self-position estimation is performed using the feature point of the internal scene 302, the self-position of the HMD 100 inside the moving body can be estimated.

### Moving Amount Based on Position and Orientation Detected by Orientation Sensor Unit 204

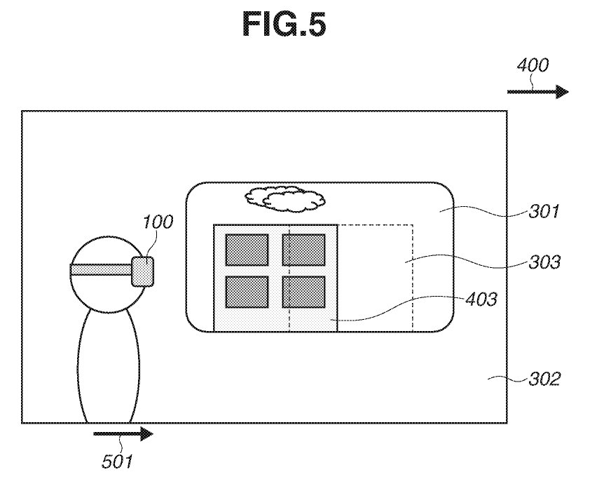

Moving amount calculation processing using the position and the orientation acquired by the orientation sensor unit 204 will now be described with reference to FIG. 5. FIG. 5 illustrates an example of the moving amount detected by the orientation sensor unit 204. The orientation sensor unit 204 can acquire a moving acceleration and a direction of the HMD 100. The orientation sensor unit 204 calculates a moving amount 501 of the HMD 100 by accumulating the information periodically acquired. The moving amount 501 of the HMD 100 is a three-dimensional moving amount. The moving amount may be indicated by being divided into three components based on a reference coordinate determined for the HMD 100. Further, in addition to the moving amount, the orientation may be represented by being divided into three components of roll, pitch, and yaw that are rotational components of a three-dimensional vector.

### Method of Providing Two Types of Self-Position Estimation Results

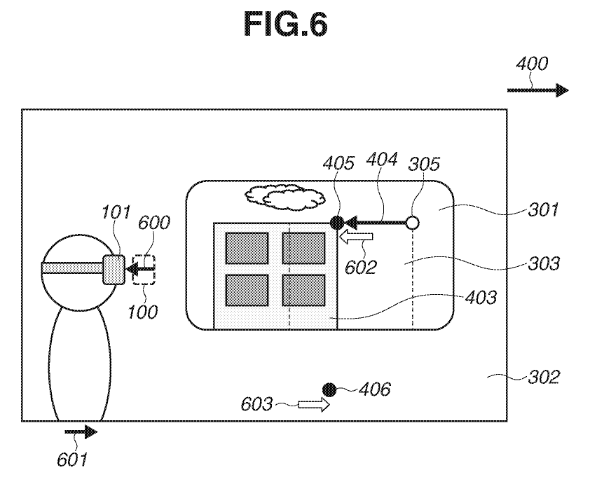

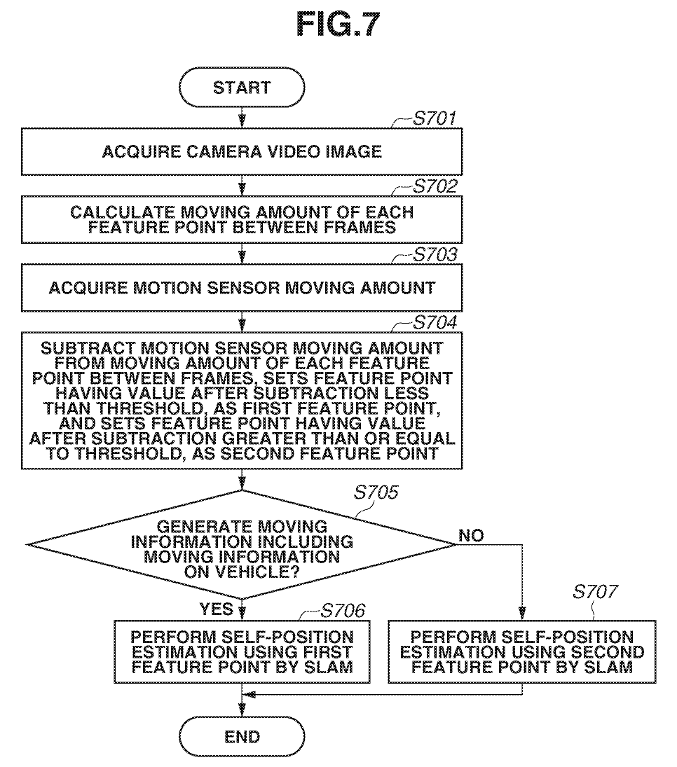

The processing for providing two types of self-position estimation results is described with reference to FIG. 3, FIG. 6, and FIG. 7.

FIG. 6 is a diagram illustrating the self-position estimation processing and the moving amount calculation processing based on the position and the orientation detected by the orientation sensor unit 204 in a case where the moving body moves and the user also moves inside the moving body. FIG. 6 illustrates a case where the user moves in the scene illustrated in FIG. 4. FIG. 6 illustrates that the user moves to a position of an HMD 101 by a length of an arrow in a direction indicated by the moving amount 600 inside the moving body. In other words, FIG. 6 illustrates that the HMD 100 moves to the position of the HMD 101 by the length of the arrow in the direction indicated by the moving amount 600 inside the moving body.

FIG. 7 is a flowchart illustrating a flow of the processing for providing two types of self-position estimation results.

In step S701, the control unit 211 controls the imaging unit 202, and stores a video image obtained by imaging a periphery of the user, in the work memory 213. Imaging is continuously performed, and the camera video image is repeatedly stored in the work memory 213.

In step S702, the control unit 211 detects feature points of the camera video image stored in the work memory 213, and stores positional information on the feature points detected for each frame in the work memory 213. In addition, the control unit 211 compares positions of each feature point between the frames to calculate a moving amount of each feature point between the frames. As illustrated in FIG. 6, it is detected that the outside feature point 405 detected in the window 301 provided on the moving body has been moved by a moving amount 602 by movement of the moving body and movement of the user inside the moving body. It is also detected that a feature point 406 of the internal scene 302 has been moved by a moving amount 603 by movement of the user inside the moving body.

In step S703, the control unit 211 acquires a moving amount 601 of the HMD 100 from the orientation sensor unit 204. For the moving amount 601 of the HMD 100, a moving amount obtained by adding movement of the moving body and movement of the user inside the moving body is detected. The moving amount of the moving body and the moving amount of the user inside the moving body cannot be detected only from the moving amount 601 detected by the orientation sensor unit 204, and thus the moving amount of the user as viewed from the outside of the moving body is detected.

In step S704, the control unit 211 converts the moving amount 501 of the HMD 100 into a moving amount on the camera video image. For example, a method is considered of selecting one of the feature points on the camera video image and calculating the moving amount of the selected feature point from positional information that is obtained by adding the moving amount 501 of the HMD 100 to the self-position serving as the three-dimensional positional information.

As illustrated in FIG. 4, a case is assumed in which the moving body moves in a front direction and the HMD worn by the user does not move at all inside the moving body, and it is assumed that a positive value is detected as the moving amount by the orientation sensor unit 204. In FIG. 4, the feature point 305 and the feature point 405 are feature points detected in the region 301 (the window 301) corresponding to a region outside the moving body, and the feature point 406 is a feature point that has been detected inside the moving body. In this case, it is assumed that, as the moving amount of the feature point detected in the region 301 corresponding to the region outside the moving body among the feature points on the camera video image, a negative value having an equal absolute value is detected by the orientation sensor unit 204. As described above, the moving direction of the feature point on the camera video image is opposite to the moving direction of the HMD 100 detected by the orientation sensor unit 204. Thus, the sign of the detected moving amount of the feature point is inverted to convert the moving amount 501 of the HMD 100 into the moving amount on the camera video image. Thereafter, the moving amount of the HMD 100 on the camera video image converted from the moving amount 501 of the HMD 100 is subtracted from the moving amount of each feature point between the frames. The feature point 305 moves to the position of the feature point 405, and moves by a length of an arrow 404 (the moving amount 404) on the camera video image. The moving amount of the arrow 400 is subtracted from the moving amount of the arrow 404 (the moving amount 404). When an error is not considered, the absolute value of the moving amount after subtraction becomes zero in the drawing. As described above, the feature point having the absolute value of the moving amount after subtraction less than a predetermined threshold is determined as a first feature point in the region outside the vehicle, and is stored in the work memory 213. At this time, in a case where a stationary object in the region outside the vehicle is used as a feature point, it is assumed that, as a result of subtraction, the moving amount becomes zero; however, the predetermined threshold is set to a value considering an error because the error may occur.

Further, in a case where the user does not move inside the vehicle, the moving amount of the feature point 406 on the camera video image becomes zero. The moving amount of the arrow 400 is subtracted from the moving amount of the feature point having the moving amount of zero. When an error is not considered, the absolute value of the moving amount after subtraction becomes equivalent to the absolute value of the moving amount of the arrow 400 in the drawing. As described above, the feature point having the absolute value of the moving amount after subtraction greater than or equal to a predetermined threshold is determined as a second feature point in the region inside the vehicle, and is stored in the work memory 213. The predetermined threshold for determination of the first feature point and the predetermined threshold for determination of the second feature point may be set to the same value or different values.

It is assumed that, in the region outside the vehicle, an object that is actually stopped but is viewed as if the object is relatively moving, such as a building as well as a moving object such as an automobile is detected. In the present embodiment, when the error is not considered, among the feature points each having the absolute value of the moving amount after subtraction greater than or equal to the threshold, the feature points in the region inside the vehicle each have the absolute value of the moving amount after subtraction equivalent to the moving amount of the moving body. Therefore, the feature points in the region inside the vehicle have similar values as the absolute values of the moving amounts after subtraction. In a case where a large number of feature points having similar values are detected as a result of subtraction, these feature points are determined as a second feature point group, and are stored in the work memory 213. It may be determined whether the feature points have similar values, based on whether the values are close to each other within a range of a certain degree of error. Among the feature points determined as the second feature point group, the feature point surrounded by the feature points detected as the first feature points in the region outside the vehicle may be determined not to be the feature point in the region inside the vehicle, and determined not to be a second feature point group.

Note that the sign of the moving amount by the orientation sensor unit 204 may be inverted to perform conversion based on the moving amount on the camera video image, namely, the direction of the moving amount of the feature point detected from the captured image. In consideration of the opposite directions, in place of subtraction, addition may be performed in a state where the sign of the moving amount by the orientation sensor unit 204 and the sign of the moving amount on the camera video image are opposite to each other.

In step S705, the control unit 211 determines which of the first feature point and the second feature point is used for the self-position estimation. In a case where the self-position estimation is performed using the first feature point, namely, the feature point in the region outside the vehicle, the processing proceeds to step S706. In a case where the self-position estimation is performed using the second feature point, namely, the feature point in the region inside the vehicle, the processing proceeds to step S707. The control unit 211 determines the feature point to be used for the self-position estimation based on the fact that an application selected by the user uses the first feature point or the second feature point.

In step S706, the control unit 211 performs the self-position estimation by using the first feature point, namely, the feature point in the region outside the vehicle. Thereafter, the processing ends.

After the self-position estimation is performed in step S706, the control unit 211 may draw a virtual object based on an estimation result of the self-position estimation.

After the self-position estimation is performed in step S706, the estimation result may be transmitted to the application selected by the user.

In step S707, the control unit 211 performs the self-position estimation based on the second feature point, namely, the feature point in the region inside the vehicle. Thereafter, the processing ends.

After the self-position estimation is performed in step S707, the control unit 211 may draw a virtual object based on the estimation result of the self-position estimation.

After the self-position estimation is performed in step S707, the estimation result may be transmitted to the application selected by the user.

Although the present disclosure is described in detail based on the desirable embodiment, the present disclosure is not limited to the specific embodiment, and various forms within a range not departing from the gist of the disclosure are also included in the present disclosure. The above-described embodiment may be appropriately partially combined.

### Other Embodiment

The present disclosure is also realized by performing the following processing. Namely, the processing is processing for supplying software (program) realizing the functions of the above-described embodiment to a system or an apparatus through a network or various kinds of storage media, and causing a computer (or control unit, microprocessor unit (MPU), etc.) of the system or the apparatus to read out and execute program codes. In this case, the program and the storage medium storing the program configure the present disclosure.

As described above, the present disclosure is described in detail based on the desirable embodiment, but the present disclosure is not limited to the specific embodiment, and various forms within a range not departing from the gist of the disclosure are also included in the present disclosure. The above-described embodiment may be appropriately partially combined.

Each functional unit according to each embodiment (each modification) may or may not be individual hardware. Functions of two or more functional units may be realized by common hardware. Each of a plurality of functions of a single functional unit may be realized by individual hardware. Two or more functions of a single functional unit may be realized by common hardware. In addition, each functional unit may or may not be realized by hardware such as an application specific integrated circuit (ASIC), a field programmable gate array (FPGA), and a digital signal processor (DSP). For example, an apparatus may include a processor and a memory (storage medium) storing a control program. Furthermore, functions of at least a part of the functional units included in the apparatus may be realized by the processor reading out the control program from the memory and executing the control program.

The present disclosure can be realized by supplying a program realizing one or more functions of the above-described embodiment to a system or an apparatus through a network or a storage medium, and causing one or more processors in a computer of the system or the apparatus to read out and execute the program. Further, the present disclosure can be realized by a circuit (e.g., ASIC) realizing one or more functions.

According to the present disclosure, in a case where a user rides in a moving body, it is possible to provide an information processing apparatus capable of distinguishing and acquiring a position and an orientation of the user including a position and an orientation of the moving body, and a position and an orientation of the user inside the moving body, without preparing a separate motion sensor.

Disclosure of the present embodiment includes configurations, a method, a program, and a system described below.

### Configuration 1

An information processing apparatus communicating with a display apparatus, the information processing apparatus including

a first acquisition unit for acquiring a detection result of an inertial sensor included in the display apparatus,

a second acquisition unit for acquiring a captured image from an imaging unit included in the display apparatus,

a detection unit for detecting a feature point of a subject from the captured image acquired by the second acquisition unit,

a determination unit for determining whether the feature point corresponds to a first feature point group or a second feature point group different from the first feature point group, based on the detection result of the inertial sensor acquired by the first acquisition unit, and the feature point detected by the detection unit, and

an estimation unit for performing estimation of a position or an orientation of the display apparatus based on the first feature point group, or estimation of a position or an orientation of the display apparatus based on the second feature point group.

### Configuration 2

The information processing apparatus according to Configuration 1, wherein the information processing apparatus is provided in the display apparatus.

### Configuration 3

The information processing apparatus according to Configuration 1 or 2, further including a third acquisition unit for acquiring a moving amount of the feature point,

wherein the determination unit determines whether the feature point corresponds to the first feature point group or the second feature point group, based on the detection result of the inertial sensor acquired by the first acquisition unit and the moving amount of the feature point acquired by the third acquisition unit .

### Configuration 4

The information processing apparatus according to Configuration 3, wherein the determination unit determines whether the feature point corresponds to the first feature point group or the second feature point group, based on a first value obtained by subtracting the moving amount based on the detection result of the inertial sensor from the moving amount of the feature point.

### Configuration 5

The information processing apparatus according to Configuration 4, wherein, in a case where the first value is less than a predetermined threshold, the determination unit determines that the feature point corresponds to the first feature point group.

### Configuration 6

The information processing apparatus according to Configuration 4 or 5, wherein, in a case where the first value is greater than or equal to a predetermined threshold, and first values of a plurality of feature points are values within a predetermined range, the determination unit determines that the plurality of feature points corresponds to the second feature point group.

### Configuration 7

The information processing apparatus according to Configuration 6, wherein, in a case where the first value is greater than or equal to the predetermined threshold, but the feature point is surrounded by feature points corresponding to the first feature point group, the determination unit determines that the feature point does not correspond to the second feature point group.

### Configuration 8

The information processing apparatus according to any one of Configurations 1 to 7, wherein, in a case where the estimation unit performs estimation of the position or the orientation of the display apparatus based on the first feature point group, the estimation unit performs the estimation of the position or the orientation of the display apparatus based on the detection result of the inertial sensor acquired by the first acquisition unit .

### Configuration 9

The information processing apparatus according to any one of Configurations 1 to 8, wherein the estimation unit performs estimation of the position or the orientation of the display apparatus based on the first feature point group or estimation of the position or the orientation of the display apparatus based on the second feature point group, based on an application selected by a user.

### Configuration 10

The information processing apparatus according to Configuration 9, further including communication unit for transmitting an estimation result by the estimation unit to the application.

### Configuration 11

The information processing apparatus according to Configuration 10,

wherein the estimation unit performs estimation of the position or the orientation of the display apparatus based on the first feature point group, and estimation of the position or the orientation of the display apparatus based on the second feature point group, and

wherein the communication unit transmits a result of the estimation based on the first feature point group and a result of the estimation based on the second feature point group by the estimation unit , to the application.

### Configuration 12

The information processing apparatus according to any one of Configurations 1 to 11, further including a drawing unit for drawing a virtual object based on an estimation result by the estimation unit .

### Method

A method of controlling an information processing apparatus communicating with a display apparatus, the method including

acquiring, as a first acquisition step, a detection result of an inertial sensor included in the display apparatus,

acquiring, as a second acquisition step, a captured image from an imaging unit included in the display apparatus,

detecting, as a detection step, a feature point of a subject from the captured image acquired in the second acquisition step,

determining, as a determination step, whether the feature point corresponds to a first feature point group or a second feature point group different from the first feature point group, based on the detection result of the inertial sensor acquired in the first acquisition step, and the feature point detected in the detection step, and

estimating, as an estimation step, estimation of a position or an orientation of the display apparatus based on the first feature point group, or estimation of a position or an orientation of the display apparatus based on the second feature point group.

### Program

A program for causing a computer to function as each unit of the information processing apparatus according to any one of Configurations 1 to 12.

### System

An information processing system including

a display apparatus,

a first acquisition apparatus for acquiring a detection result of an inertial sensor included in the display apparatus,

a second acquisition apparatus for acquiring a captured image from an imaging unit included in the display apparatus,

a detection apparatus for detecting a feature point of a subject from the captured image acquired by the second acquisition apparatus,

a determination apparatus for determining whether the feature point corresponds to a first feature point group or a second feature point group different from the first feature point group, based on the detection result of the inertial sensor acquired by the first acquisition apparatus and the feature point detected by the detection apparatus, and

an estimation apparatus for performing estimation of a position or an orientation of the display apparatus based on the first feature point group, or estimation of a position or an orientation of the display apparatus based on the second feature point group.

The present disclosure is not limited to the above-described embodiment, and can be variously changed and modified without departing from the spirit and the scope of the present disclosure. Therefore, to apprise the public of the scope of the present disclosure, the following claims are attached.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An information processing apparatus communicating with a display apparatus, the information processing apparatus comprising:
one or more processors and/or circuitry configured to
execute first acquisition processing of acquiring a detection result of an inertial sensor included in the display apparatus;
execute second acquisition processing of acquiring a captured image from an imaging unit included in the display apparatus;
execute detection processing of detecting a feature point of a subject from the captured image acquired in the second acquisition processing;
execute determination processing of determining whether the feature point corresponds to a first feature point group or a second feature point group different from the first feature point group, based on the detection result of the inertial sensor acquired in the first acquisition processing, and the feature point detected in the detection processing; and
execute estimation processing of performing estimation of a position or an orientation of the display apparatus based on the first feature point group, or estimation of a position or an orientation of the display apparatus based on the second feature point group.

2. The information processing apparatus according to claim 1, wherein the information processing apparatus is provided in the display apparatus.

3. The information processing apparatus according to claim 1, wherein the one or more processors and/or circuitry further executes third acquisition processing of acquiring a moving amount of the feature point,
wherein, in the determination processing, whether the feature point corresponds to the first feature point group or the second feature point group is determined, based on the detection result of the inertial sensor acquired by the first acquisition processing and the moving amount of the feature point acquired by the third acquisition processing.

4. The information processing apparatus according to claim 3, wherein, in the determination processing, whether the feature point corresponds to the first feature point group or the second feature point group is determined, based on a first value obtained by subtracting a moving amount based on the detection result of the inertial sensor from the moving amount of the feature point.

5. The information processing apparatus according to claim 4, wherein, in a case where the first value is less than a predetermined threshold, it is determined that the feature point corresponds to the first feature point group in the determination processing.

6. The information processing apparatus according to claim 4, wherein, in a case where the first value is greater than or equal to a predetermined threshold, and first values of a plurality of feature points are values within a predetermined range, it is determined that the plurality of feature points corresponds to the second feature point group in the determination processing.

7. The information processing apparatus according to claim 6, wherein, in a case where the first value is greater than or equal to the predetermined threshold, but the feature point is surrounded by feature points corresponding to the first feature point group, it is determined that the feature point does not correspond to the second feature point group in the determination processing.

8. The information processing apparatus according to claim 1, wherein, in the estimation processing, in a case where estimation of the position or the orientation of the display apparatus is performed based on the first feature point group, the estimation of the position or the orientation of the display apparatus is performed based on the detection result of the inertial sensor acquired by the first acquisition processing.

9. The information processing apparatus according to claim 1, wherein, in the estimation processing, estimation of the position or the orientation of the display apparatus based on the first feature point group is performed, or estimation of the position or the orientation of the display apparatus based on the second feature point group is performed, in accordance with an application selected by a user.

10. The information processing apparatus according to claim 9, wherein the one or more processors and/or circuitry further executes communication processing of transmitting an estimation result by the estimation processing to the application.

11. The information processing apparatus according to claim 10,
wherein, in the estimation processing, estimation of the position or the orientation of the display apparatus based on the first feature point group is performed, and estimation of the position or the orientation of the display apparatus based on the second feature point group is performed, and
wherein, in the communication processing, a result of the estimation based on the first feature point group and a result of the estimation based on the second feature point group that are performed by the estimation processing are transmitted to the application.

12. The information processing apparatus according to claim 1, wherein the one or more processors and/or circuitry further executes drawing processing of drawing a virtual object based on an estimation result by the estimation processing.

13. A method of controlling an information processing apparatus communicating with a display apparatus, the method comprising:
acquiring, as a first acquisition step, a detection result of an inertial sensor included in the display apparatus;
acquiring, as a second acquisition step, a captured image from an imaging unit included in the display apparatus;
detecting, as a detection step, a feature point of a subject from the captured image acquired in the second acquisition step;
determining, as a determination step, whether the feature point corresponds to a first feature point group or a second feature point group different from the first feature point group, based on the detection result of the inertial sensor acquired in the first acquisition step, and the feature point detected in the detection step; and
estimating, as an estimation step, estimation of a position or an orientation of the display apparatus based on the first feature point group, or estimation of a position or an orientation of the display apparatus based on the second feature point group.

14. A non-transitory computer-readable storage medium storing a program for causing a computer to function as each processing of the information processing apparatus according to claim 1.

15. An information processing system comprising:
a display apparatus;
a first acquisition apparatus for acquiring a detection result of an inertial sensor included in the display apparatus;
a second acquisition apparatus for acquiring a captured image from an imaging unit included in the display apparatus;
a detection apparatus for detecting a feature point of a subject from the captured image acquired by the second acquisition apparatus;
a determination apparatus for determining whether the feature point corresponds to a first feature point group or a second feature point group different from the first feature point group, based on the detection result of the inertial sensor acquired by the first acquisition apparatus and the feature point detected by the detection apparatus; and
an estimation apparatus for performing estimation of a position or an orientation of the display apparatus based on the first feature point group, or estimation of a position or an orientation of the display apparatus based on the second feature point group.
